(19) United States
(12) Patent Application Publication
(10) Pub. No.: US 2012/0050954 A1
(43) Pub. Date: Mar. 1, 2012

(54) SOLID ELECTROLYTIC CAPACITOR AND A METHOD FOR MANUFACTURING THE SAME

(75) Inventors: Makoto SHIRAKAWA, Kusatsu-city (JP); Takeshi SANO, Takatsuki-city (JP); Masayuki FUJITA, Kyoto-city (JP)

(73) Assignee: SANYO ELECTRIC CO., LTD., Moriguchi-city (JP)

(21) Appl. No.: 13/218,709

(22) Filed: Aug. 26, 2011

(30) Foreign Application Priority Data
Aug. 27, 2010 (JP) 2010-190521

(51) Int. Cl. H01G 9/042; H01G 9/00

(52) U.S. Cl. 361/528; 29/25.03

(57) ABSTRACT

Low ESR solid electrolytic capacitors and methods for their manufacture are described having anode-associated concave portions. The solid electrolytic capacitor in an embodiment has an anode terminal, which includes a terminal main body and a valve metal layer formed on the surface of the terminal main body. At least one concave portion is formed on the surface of the anode terminal, and an anode is formed in the concave portion on the anode terminal, wherein the anode is formed by a porous body comprising valve metal. A dielectric layer is formed on the anode, and a cathode is formed on the dielectric layer.

### CROSS REFERENCE TO RELATED APPLICATIONS

This application of the invention titled “SOLID ELECTROLYTIC CAPACITOR AND A METHOD FOR MANUFACTURING THE SAME” is based upon and claims the benefit of priority under 35 USC 119 from prior Japanese Patent Application No. 2010-190521, filed on Aug. 27, 2010; the entire contents of which are incorporated herein by reference.

### BACKGROUND OF THE INVENTION

1. Field of the Invention

The claimed invention relates to a solid electrolytic capacitor and a method for manufacturing the same.

2. Description of Related Art

In recent years, highly efficient solid electrolytic capacitors are in high demand with the advent of high performance electronic devices. Among these, demands for solid electrolytic capacitors of even lower equivalent series resistance (ESR) are especially high.

The most widely-used conventional solid electrolytic capacitor has a portion of a cylinder-shaped anode terminal buried in an anode formed by a porous body comprising valve metals. However, such solid electrolytic capacitor not only has a reduced sectional area, but also has a reduced contact area between the anode terminal and the anode. In such a solid electrolytic capacitor, it is difficult to decrease the electrical resistance between the anode and the anode terminal contact. Accordingly, it is difficult to lower the ESR sufficiently in the solid electrolytic capacitor having a portion of the anode terminal buried in the anode.

An example of a solid electrolytic capacitor with an embodiment other than the one having a portion of the cylinder-shaped anode terminal buried in the anode is shown in JP2004-241435. Namely, a solid electrolytic capacitor having a plate-like shaped anode terminal is attached to a surface of a cuboid anode is shown in JP2004-241435.

The solid electrolytic capacitor described in JP2004-241435 may have increased contact area between the anode and the anode terminal. This may have lowered ESR. However, demands exist for even lower ESR in solid electrolytic capacitors.

### SUMMARY OF THE INVENTION

An aspect of the invention provides a solid electrolytic capacitor including an anode terminal, wherein the anode terminal includes a terminal main body and a valve metal layer formed on the surface of the terminal main body, wherein at least one concave portion is formed on the surface of the anode terminal, an anode formed in the concave portion on the anode terminal, wherein the anode is formed by a porous body including valve metals, a dielectric layer formed on the anode, and a cathode formed on the dielectric layer.

Another aspect of the invention provides a method for manufacturing a solid electrolytic capacitor including a step for preparing an anode terminal on which a concave portion is formed, a step for forming an anode formed by a porous body including valve metals in the concave portion, a step for forming a dielectric layer on the anode by anodizing the anode, and a step for forming a cathode on the dielectric layer.

According to the solid electrolytic capacitor of an embodiment, the anode is disposed in concave portions formed on the surface of the anode terminal. Therefore, the contact surface between the anode and the anode terminal is larger compared to an anode terminal that does not have concave portions. Accordingly, the electrical resistance at the contact portion between the anode and the anode terminal may be decreased. Consequently, the ESR may be further reduced.

### BRIEF DESCRIPTION OF THE DRAWINGS

FIG. 1 is a schematic perspective view of a solid electrolytic capacitor according to a first embodiment.

FIG. 2 is a schematic cross-sectional view taken along lines II-II in FIG. 1.

FIG. 3 is a partially enlarged schematic cross-sectional view of the solid electrolytic capacitor according to the first embodiment.

FIG. 4 is a schematic cross-sectional view taken along lines IV-IV in FIG. 2.

FIG. 5 is a schematic cross-sectional view of a solid electrolytic capacitor according to a second embodiment.

FIG. 6 is a schematic cross-sectional view of a solid electrolytic capacitor according to a third embodiment.

FIG. 7 is a schematic cross-sectional view of a solid electrolytic capacitor according to a fourth embodiment.

FIG. 8 is a schematic cross-sectional view of a solid electrolytic capacitor according to a fifth embodiment.

FIG. 9 is a schematic perspective view of a solid electrolytic capacitor according to a sixth embodiment.

FIG. 10 is a schematic cross-sectional view of a solid electrolytic capacitor according to a seventh embodiment.

### DETAILED DESCRIPTION OF EMBODIMENTS

Embodiments of the invention are explained with reference to the drawings. In the respective drawings referenced herein, the same constituents are designated by the same reference numerals and duplicate explanation concerning the same constituents is omitted. All drawings illustrate the respective examples only. No dimensional proportions in the drawings restrict the embodiments. For this reason, specific dimensions and the like are interpreted with the following descriptions taken into consideration. In addition, the drawings include parts whose dimensional relationship and ratios are different from one drawing to another.

Prepositions, such as “on”, “over” and “above” may be defined with respect to a surface, for example a layer surface, regardless of that surface's orientation in space. The preposition “above” may be used in the specification and claims even if a layer is in contact with another layer. The preposition “on” may be used in the specification and claims when a layer is not in contact with another layer, for example, when there is an intervening layer between them.

### First Embodiment

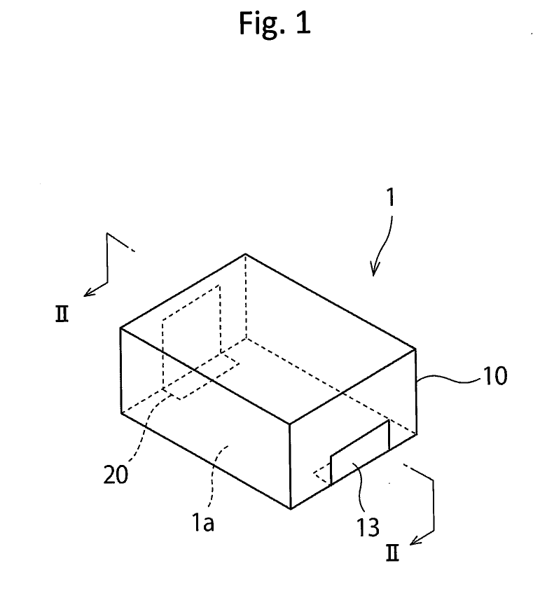

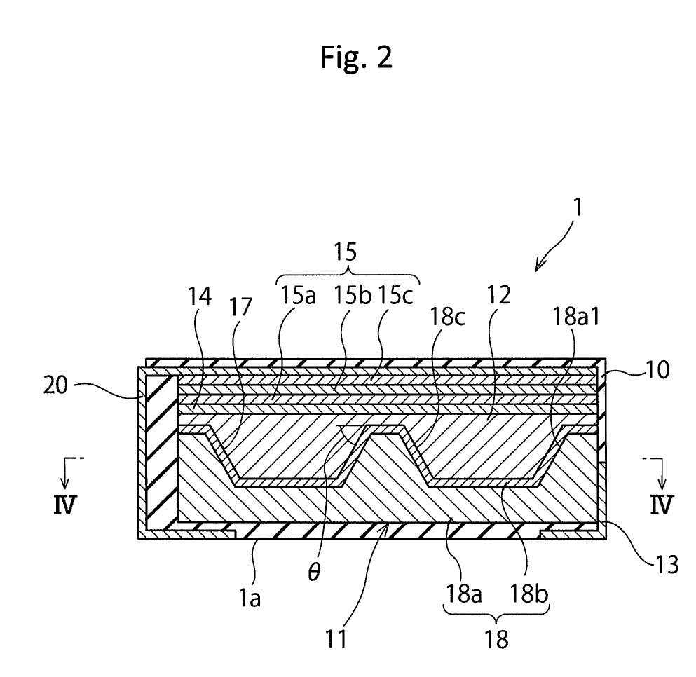

FIG. 1 is a schematic perspective view of a solid electrolytic capacitor according to a first embodiment. FIG. 2 is a schematic cross-sectional view taken along lines II-II in FIG. 1.

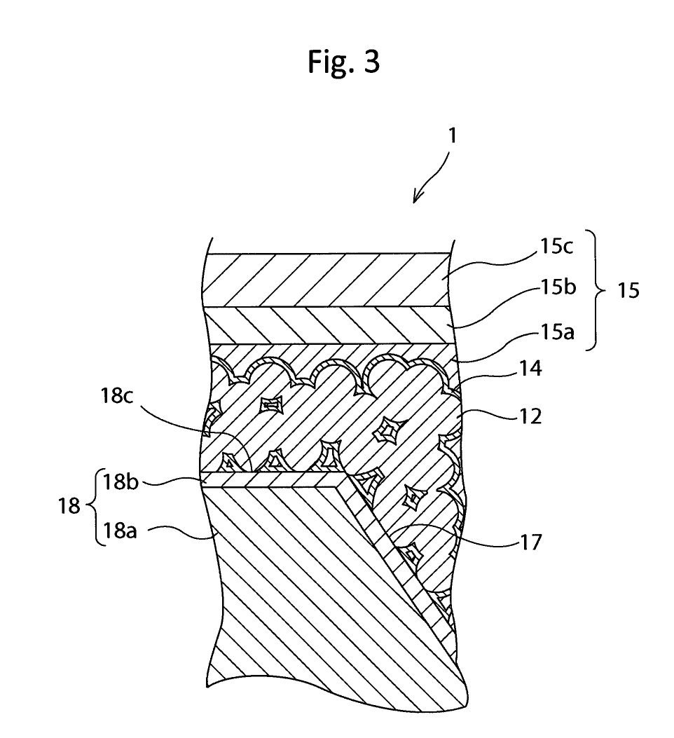

FIG. 3 is a partially enlarged schematic cross-sectional view of the solid electrolytic capacitor according to the first embodiment.

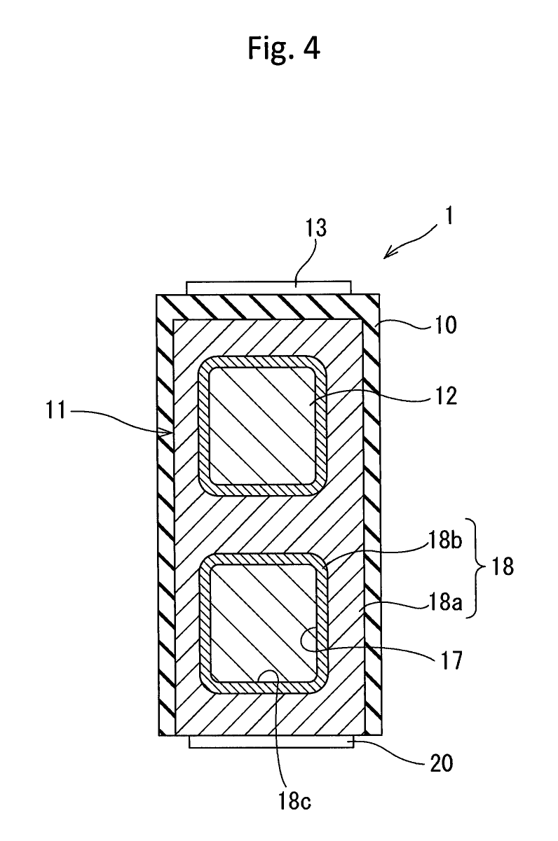

FIG. 4 is a schematic cross-sectional view taken along lines IV-IV in FIG. 2. Note that internal components of the solid electrolytic capacitor in FIG. 1 are omitted for convenience of illustration.

First, a configuration of solid electrolytic capacitor 1 according to the first embodiment is explained by referring to FIGS. 1-4.

As shown in FIG. 2, solid electrolytic capacitor 1 has capacitor element 11. Capacitor element 11 includes anode 12, dielectric layer 14, cathode layer 15, and anode terminal 18.

As shown in FIG. 3, anode 12 includes a porous body comprising valve metals. Specifically, a porous body forming anode 12 may contain valve metal, alloys including valve metals, or oxides of valve metals such as niobium monoxide. If the porous body that forms anode 12 contains alloys with valve metal, the valve metal preferably comprises more than 50% of the alloy mass.

Examples of valve metals are niobium, tantalum, titanium, aluminum, hafnium, zirconium, zinc, tungsten, bismuth, antimony, and the like. Titanium, tantalum, aluminum, and niobium in particular are preferred valve metals because raw materials of these metals are readily available.

As shown in FIG. 2, anode 12 is formed on a plate-like shaped anode terminal 18. Anode terminal 18 has terminal main body 18a and valve metal layer 18b.

Terminal main body 18a is formed by, for example, metals such as copper, tungsten, nickel, titanium, silver, gold, platinum, and rhodium, or conductive materials such as alloys that contain one or more of the above-mentioned metals. Preferably anode terminal main body 18a is formed with materials having lower electrical resistance than that of materials used for valve metal layer 18b. Among others, copper and nickel alloys are preferable for forming terminal main body 18a because copper is inexpensive and its electrical resistance is low, while nickel alloys have low electrical resistance and high deflective strength.

Valve metal layer 18b is formed on one-side surface 18a1 (see FIG. 2) of anode 12 side of terminal main body 18a. In the embodiment, surface 18a1 of terminal main body 18a is covered by valve metal layer 18b. Therefore, the surface layer of anode terminal 18 is formed by valve metal layer 18b.

Valve metal layer 18b includes valve metals. Specifically, valve metal layer 18b is formed by, for example, valve metal, alloys containing valve metals, and the like. Valve metals that are preferably used for forming valve metal layer 18b are the above-mentioned valve metals that are listed as materials for anode 12.

The thickness of valve metal layer 18b is not specifically limited. The thickness may be, for example, 0.2 μm-1 μm.

Multiple concave portions 17 are formed on the one-side of surface 18c of anode terminal 18 that is formed by valve metal layer 18b. Specifically, concave portion 17 is provided by forming a concaved part on the surface of terminal main body 18a and forming valve metal layer 18b on the concaved part.

The above-mentioned anode 12 is formed inside concave portion 17. Specifically, in the embodiment, anode 12 is formed on the entire surface 18c that includes the surface of concave portion 17, so as to contact with surface 18c. This way, anode 12 and anode terminal 18 are electronically connected.

Note that concave portion 17 is formed to taper inwardly from the surface of anode terminal 18. Namely, concave portion 17 is tapered toward the bottom of the concave shape. Specifically, concave portion 17 is formed to have a substantially inverted trapezoidal shape in a sectional view. Base angle θ of the inverted trapezoidal shape is not specifically limited. For example, a preferable angle may be within 40°-60°.

The depth of concave portion 17 is, for example, preferably around 100 μm-500 μm. The preferable ratio of the depth of concave portion 17 to the thickness of anode terminal 18 (“the depth of concave portion 17”/“the thickness of anode terminal 18”) is around 0.5-2.

As shown in FIGS. 2 and 3, dielectric layer 14, which contains oxides of valve metals, is formed on the surface of anode 12 and valve metal layer 18b. Specifically, dielectric layer 14 is formed by oxidizing the surface layer of anode 12 and valve metal layer 18b in this embodiment.

Note that dielectric layer 14 in FIG. 2 is illustrated schematically for the convenience. In an actual configuration, dielectric layer 14 forms not only on the outer surface of anode 12 and valve metal layer 18b, but also on surfaces that face internal air spaces in anode 12 (hereinafter “internal surfaces.”)

The thickness of dielectric layer 14 is, for example, preferably around 10 nm-500 nm. If dielectric layer 14 is too thick, the electrostatic capacitance may decrease. Also, such large thickness may cause dielectric layer 14 to readily detach from anode 12. If the dielectric layer 14 is too thin, such may cause decreased voltage resistance and increased leakage current.

Cathode layer 15 is formed on dielectric layer 14. Cathode layer 15 includes conductive polymer layer 15a. Specifically, in the embodiment, cathode layer 15 is formed by a laminated body that includes conductive polymer layer 15a, carbon layer 15b, and silver layer 15c. However, this embodiment is not limited by this configuration. For example, cathode layer 15 may be formed by conductive polymer layer 15a only, or by conductive polymer layer 15a and either one of carbon layer 15b, or silver layer 15c.

Conductive polymer layer 15a is formed on dielectric layer 14. As shown in FIG. 3, in detail, conductive polymer layer 15a is formed inside anode 12 as well. In other words, conductive polymer layer 15a is not only formed on dielectric layer 15a that is formed on the outer surface of anode 12, but also formed on dielectric layer 14 that is formed on inner surfaces of anode 12.

Conductive polymer layer 15a is formed by, for example, conductive polymers such as polypyrrole, polyethylenedioxythiophene, polythiophene, polyaniline, and the like.

Carbon layer 15b is formed on conductive polymer layer 15a. More specifically, carbon layer 15b is formed on the portion wherein conductive polymer layer 15a is formed on the outer surface of anode 12. Silver layer 15c is formed on carbon layer 15b.

As shown in FIG. 2, cathode layer 15 connects to cathode lead frame 20 via a conductive adhesive. Anode terminal 18 is connected to the anode lead frame via a conductive adhesive. Note that the conductive adhesive is not specifically limited. For example, the adhesive may be a silver paste that contains fine silver particles.

Capacitor element 11 is molded with a resin. Namely, capacitor element 11 is covered by resin outer package body 10. This way, capacitor element 11 is sealed. Note that anode lead frame 13 and cathode lead frame 20 lead to rear surface 1a of solid electrolytic capacitor 1.

As long as resin outer package body 10 can seal capacitor element 11, materials for resin outer package body 10 are not particularly limited. For example, resin outer package body 10 may be formed by a thermosetting resin composition that is commonly used as a sealant for electronic components. Examples of thermosetting resins are epoxy resins and the like.

Note that thermosetting resin compositions commonly used as sealants for electronic components generally include fillers such as silica particles, curing agents such as phenolic resins, curing accelerators such as imidazole compounds, and flexing agents such as silicone resin.

Next, an example of a method for manufacturing solid electrolytic capacitor 1 according to an embodiment is explained.

First, plate-like shaped anode terminal 18, on which concave portions 17 are formed, is prepared. Specifically, first a piece of metal plate such as a copper plate which becomes terminal main body 18a is prepared. Next, terminal main body 18a is made by forming concave portions on the metal plate. The method for forming the concave portions is not limited. The concave portions for example may be formed mechanically via a chipping means such as a drill, or by pressing. Moreover, concave portions 17 may be formed by irradiating a laser beam such as a carbon dioxide laser and the like. Note that the output power of the carbon dioxide laser may be, for example, around 10 mJ-6 mJ.

In the forming procedure of concave portion 17 by laser irradiation, the resulting shape of concave portion 17 may be controlled by adjusting the output power of the irradiating laser beam. Specifically, concaved portion 17 may be formed by multiple irradiations of the laser beam pulse. During the procedure, concave portion 17 that is inwardly tapered may be formed by gradually reducing the output power of the laser beam pulse upon every irradiation. Note that depending on the output power distribution, the center region of the bottom surface of concave portion 17 may be relatively deep. Namely, the bottom surface of the concave portion may not be flat.

Note that if a burr is formed in the process of forming concave portion 17, such a burr may be removed, for example, by etching with an etching solution containing, for example, hydrogen peroxide and sulfuric acid as essential materials.

Next, valve metal layer 18b is formed on terminal main body 18a, thereby completing anode terminal 18 with concave portions 17. The method for forming valve metal layer 18b is not specifically limited. Valve metal layer 18b may be formed by, for example, a sputtering method, the CVD (Chemical Vapor Deposition) method, the ALD (Atomic Layer Deposition) method and the like.

Next, anode 12 formed by a porous body including valve metal is formed on valve metal layer 18b of anode terminal 18. Anode 12 is also formed in concave portion 17. Specifically, anode 12 for example, may be formed according to the following method. First, a powder containing valve metal is added to a solution that contains a binder and a solvent. Then, the powder with valve metal is dispersed in the solution by using a disperser or a mixer so that a slurry is formed. The slurry is applied on valve metal layer 18b of anode terminal 18 by a screen printing method and the like, then dried, degreased, and sintered to form anode 12.

Note that a preferable diameter of particles in the powder containing valve metal is, for example, around 0.08 μm-1 μm, and more preferably, around 0.2 μm-0.5 μm. If the particle size of the powder is too large, the surface area per unit volume of anode 12 is likely to be small. If the particle size of the powder is too small, the air spaces formed inside the porous body tend to be too small.

Specific examples for a binder that is added in the slurry are acrylic resins, polyvinyl alcohol (PVA), polyvinyl butyral (PVB), polyvinyl acetate, and the like.

The sintering temperature may be adjusted depending on the kind of valve metals that are used as an ingredient, the particle size of the powder, and so on. The example of the sintering temperature of the slurry is around 900° C.-1300° C. If the sintering temperature is too low, the binder remains without sublimation. If the sintering temperature is too high, less air spaces may remain due to excessively progressed sintering.

Next, anode 12 and anode terminal 18, which are integrally formed are immersed in an aqueous solution containing phosphoric acid and the like, so as to anodize the surface layer to form dielectric layer 14 (chemical conversion treatment.) Note that if the surface of an anode terminal does not contain valve metal, the dielectric layer may not form on the exposed portion of the anode terminal surface. In that case, short circuits may occur between the anode terminal and a cathode layer. On the contrary, in the embodiment, because anode terminal 18 contains valve metals, dielectric layer 14 is reliably formed on the surface layer. Accordingly, the embodiment can effectively prevent short circuits from forming between anode terminal 18 and cathode layer 15.

Next, cathode layer 15 is formed on dielectric layer 14. Specifically, first, conductive polymer layer 15a is formed.

Conductive polymer layer 15a is formed, for example, by a chemical polymerization method, an electropolymerization method, and the like. For instance, when a chemical polymerization method is used, conductive polymer layer 15a is formed by oxidatively polymerizing monomers with an oxidation agent.

Next, carbon layer 15b is formed. Specifically, a carbon paste is applied on conductive polymer layer 15a and dried, so as to form carbon layer 15b. Subsequently, a silver paste is applied on carbon layer 15b and dried, so that silver layer 15 is formed.

Next, anode lead frame 13 and cathode lead frame 20 are connected to anode 12 and cathode layer 15, respectively. Lastly, resin outer package body 10 is formed to seal capacitor element 11, so as to complete solid electrolytic capacitor 1.

As explained above, the surface area of surface 18c is substantially large because concave portions 17 are formed on surface 18c of anode terminal 18 in the embodiment. Further, anode 12 is formed on surface 18c1 on the side where valve metal layer 18b is formed on surface 18c of such a large surface area. This way, the contact area between anode 12 and anode terminal can be larger than the one that has no concave portions formed on the anode terminal. Accordingly, the electrical resistance at the contact portion between anode 12 and anode terminal 18 can be lowered. Consequently, the ESR of solid electrolytic capacitor 1 can be further lowered.

In terms of increasing the contact area between anode 12 and anode terminal 18, a large base angle θ is preferable. Thus, base angle θ is preferably 45° or larger. Further, the volume of anode 12 is also increased by making base angle θ 45° or larger. Accordingly, the electrostatic capacitance is increased.

However, if base angle θ is too large, it would be difficult to form valve metal layer 18b of appropriate thickness on side walls of concave portions 17. Even though valve metal layer 18b may be formed on the side walls of concave portions, the thickness of valve metal layer 18b on the side walls may be too thin. In that case, dielectric layer 14 may not be formed appropriately on the exposed portion of the surface of anode terminal 18. Accordingly, the leakage current may become too large. Further, the joint strength between anode 12 and anode terminal 18 at the side walls of concave portions 17 weakens. Also, the available electrostatic capacitance may be too little and such a solid electrolytic capacitor may be less reliable. Further, if base angle θ is too large, the stress is concentrated at the both angular parts of the concave portion and makes the solid electrolytic capacitor less reliable.

Accordingly, it is preferred that concave portion 17 be inwardly tapered from the surface of anode terminal 18. Further, it is preferable that base angle θ be 60° or smaller.

Note that the thickness of anode 12 on concave portion 17 differs from the thicknesses on portions other than concave portion 17. Due to the difference of the thickness, anode 12 is subject to less stress than, for instance, an anode that has a uniformed thickness without concave portions 17. Consequently, delamination of anode 12 from anode terminal 18 can be prevented. Further, the destruction of anode 12 can be prevented. Accordingly, reliability of solid electrolytic capacitor 1 is effectively improved.

As shown in FIG. 4, in the embodiment, the center portion of solid electrolytic capacitor 1 does not have concave portion 17 in planar view. Therefore, anode 12 is relatively thin at the center portion of solid electrolytic capacitor 1. As a result, even if an outer force is exerted on solid electrolytic capacitor 1, and the stress is applied in the center portion, delamination or destruction of anode 12 is effectively prevented. Accordingly, solid electrolytic capacitors of even higher reliability may be obtained.

In a manufacturing method of solid electrolytic capacitor 1 according to the embodiment, anode 12 is formed on the surface layer of anode terminal 18 that contains valve metals, and then, dielectric layer 14 is formed by anodization. This way, dielectric layer 14 also forms reliably on exposed portions on the surface layer of anode terminal 18 that contain valve metal. Accordingly, solid electrolytic capacitor 1 of reduced leakage current may be readily produced.

Following are explanations of other examples of preferred embodiments that implement the above-mentioned embodiment. In the following descriptions, members having substantially the same functions as in the above-mentioned first embodiment are referred to with the same reference number, and the explanations of such members are omitted.

### Second Embodiment

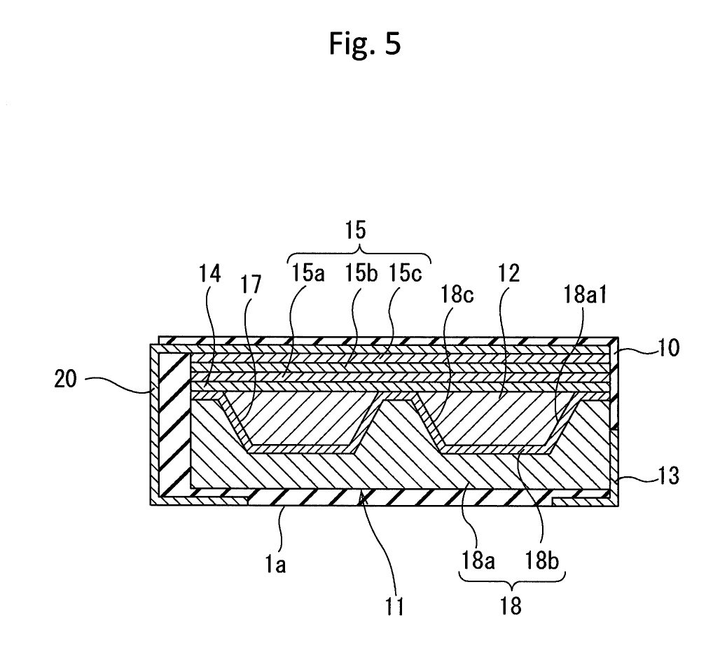

FIG. 5 is a schematic cross-sectional view of a solid electrolytic capacitor according to a second embodiment.

In the above-mentioned first embodiment, an example is described with anode 12, which is disposed on concave portions 17 as well as on other than the concave portion 17 on anode terminal 18. In the second embodiment, anode 12 is disposed individually in each one of a plurality of concave portions 17 formed on anode terminal 18 as shown in FIG. 5. Because anode 12 is formed separately in each of concave portions 17, the stress exerted on anode 12 is dispersed in segmented manner. This way, delamination of anode 12 from anode terminal 18 or destruction of anode 12 is more effectively prevented.

However, in this case, the volume of anode 12 becomes small and the surface area of anode 12 also becomes small. Accordingly, the electrostatic capacitance tends to be small. In terms of obtaining larger electrostatic capacitance, it is preferable that anode 12 be formed not only on concave portions 17, but also on other than concave portions 17 on anode terminal 18, as described in the first embodiment.

### Third Embodiment

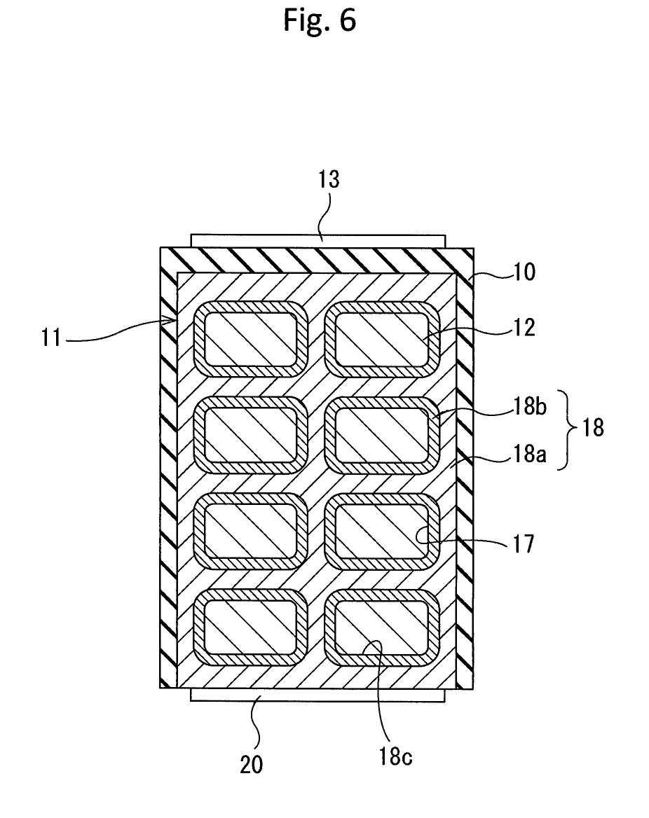

FIG. 6 is a schematic cross-sectional view of a solid electrolytic capacitor according to a third embodiment.

In the above-mentioned first embodiment, an example of forming two concave portions 17 is explained. In the third embodiment, more than three concaved portions 17 are formed in a matrix-like configuration. It is preferable that concave portion 17 not form in the vicinity of the center of solid electrolytic capacitor 1 in planar view, as in the above-mentioned first embodiment.

Note that in the embodiment, the example was explained with eight concaved portions 17. However, the number of concaved portions 17 may be 32.

### Fourth and Fifth Embodiment

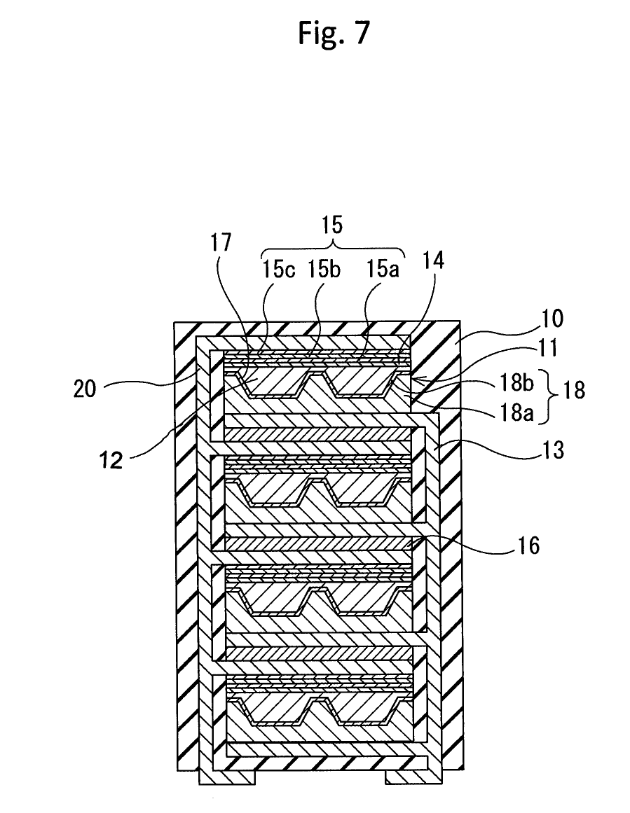

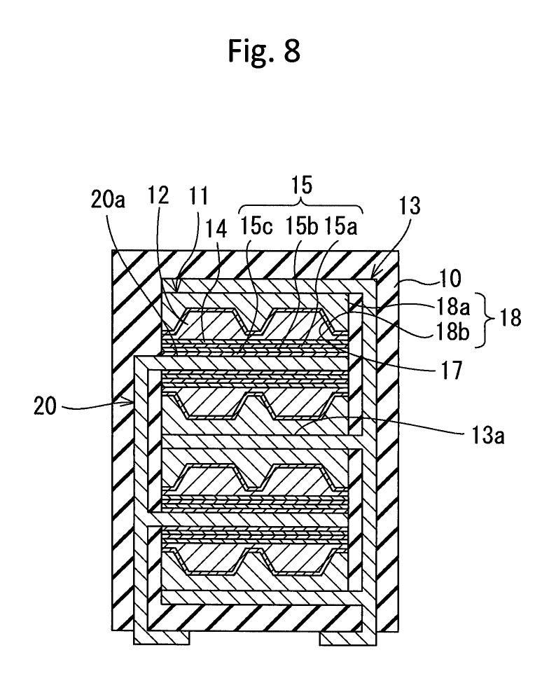

FIG. 7 is a schematic cross-sectional view of a solid electrolytic capacitor according to a fourth embodiment. FIG. 8 is a schematic cross-sectional view of a solid electrolytic capacitor according to a fifth embodiment.

In the above-mentioned first embodiment, an example is described with solid electrolytic capacitor 1 having a single capacitor element 11. In the fourth and fifth embodiments, a solid electrolytic capacitor has a plurality of capacitor elements 11 as shown in FIGS. 7 and 8. According to this configuration, the electrostatic capacitance of the solid electrolytic capacitor may be even greater. Note that when multiple capacitor elements are disposed in the single solid electrolytic capacitor, such capacitor elements are preferably arranged in a stacked manner. In that case, for example, the plurality of capacitor elements 11 may be arranged in a manner that anode terminal 18 sides face the same direction as shown in FIG. 7. The plurality of capacitor elements 11 may be stacked in a manner that anode terminal 18 sides face one direction and the other direction alternately as shown in FIG. 8. This way, layered portions 13a and 20a of anode lead frame 13 and cathode lead frame 20 on capacitor element 11 respectively may be commonly used by adjacent capacitor elements 11. As a result, the solid electrolytic capacitor may become compact.

Note that insulating layer 16 is provided between anode lead frame 13 and cathode lead frame 20 in the solid electrolytic capacitor shown in FIG. 7. Anode lead frame 13 and cathode lead frame 20 are insulated by insulating layer 16.

### Sixth Embodiment

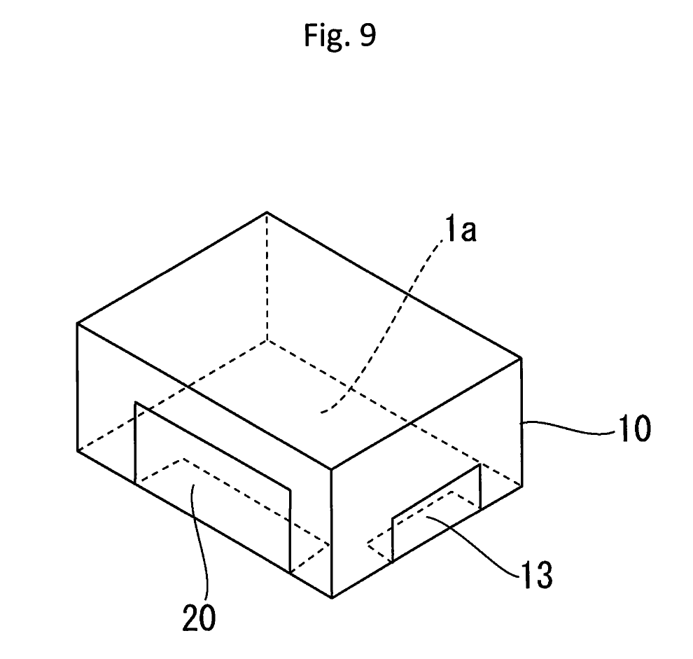

FIG. 9 is a schematic perspective view of a solid electrolytic capacitor according to a sixth embodiment. Note that in FIG. 9, internal components of the solid electrolytic capacitor are omitted for convenience.

In the above-mentioned first embodiment, cathode lead frame 20 and anode lead frame 13 are arranged in line and face each other. As shown in FIG. 9, in the sixth embodiment, cathode lead frame 20 and anode lead frame 13 are disposed in a manner that cathode lead frame 20 and anode lead frame 13 do not face each other at rear surface 1a of the solid electrolytic capacitor.

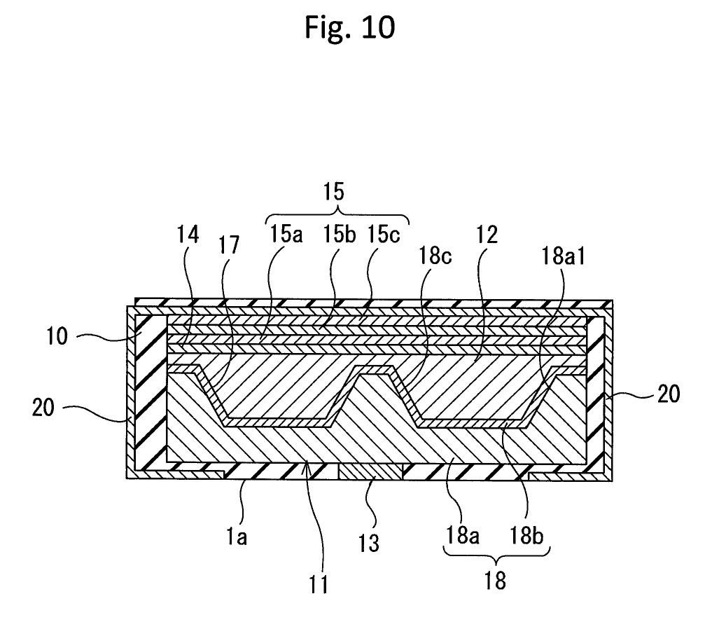

FIG. 10 is a schematic cross-sectional view of a solid electrolytic capacitor according to a seventh embodiment.

In the example described in the above-mentioned first embodiment, cathode lead frame 20 is exposed at a single part on the side of solid electrolytic capacitor 1. As shown in FIG. 10, in the seventh embodiment, cathode lead frame 20 is exposed at two parts at both sides of the solid electrolytic capacitor. Specifically, in the embodiment, anode lead frame 13 is exposed between the exposed parts of cathode lead frame 20 on rear surface 1a of the solid electrolytic capacitor. Namely, the solid electrolytic capacitor of this embodiment is a so-called three-terminal capacitor.

As described above, the solid electrolytic capacitor in the embodiment has concave portions formed on the surface of the anode terminal body. Further, multiple concave portions are formed and anodes may be formed separately in each of the concave portions. Consequently, the stress exerted to the anode is dispersed. This way, the delamination of the anode from the anode terminal or destruction of the anode is prevented. Accordingly, reliability of solid electrolytic capacitor 1 is effectively improved.

The solid electrolytic capacitor of this embodiment includes a plurality of capacitor elements each of which has an anode terminal, an anode, a dielectric layer, and a cathode. This way, the electrostatic capacitance of the solid electrolytic capacitor is increased.

The solid electrolytic capacitor of this embodiment has a concave portion that is formed to inwardly taper from the surface of the anode terminal. In this way, the valve metal layer is readily formed on the anode terminal main body having a larger surface area. Also, the side wall of the concave portion and the anode can be reliably bonded.

According to a method of manufacturing a solid electrolytic capacitor, a concave portion first is formed on an anode terminal. Then, an anode comprised of a porous body including valve metals is formed in the concave portion. A dielectric layer is formed by anodizing the anode. A cathode is formed on the dielectric layer. According to this method of manufacturing the solid electrolytic capacitor, a solid electrolytic capacitor having reduced ESR can be obtained. Also, the anode and the cathode are reliably insulated. Consequently, a solid electrolytic capacitor with suppressed leakage current may be obtained.

As explained above, according to the solid electrolytic capacitor and its manufacturing method of the embodiment, solid electrolytic capacitors having lowered ESR due to the increased contact area between the anode and anode terminal can be provided. Further, according to the solid electrolytic capacitor and its manufacturing method of the embodiment, solid electrolytic capacitors of reduced stress in the anode can be obtained.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

What is claimed is:

1. A solid electrolytic capacitor comprising:
an anode terminal, wherein the anode terminal includes a terminal main body and a valve metal layer formed on the surface of the terminal main body, wherein at least one concave portion is formed on the surface of the anode terminal,
an anode formed in the concave portion on the anode terminal, wherein the anode is formed as a porous body comprising a valve metal,
a dielectric layer formed on the anode, and
a cathode formed on the dielectric layer.

2. The solid electrolytic capacitor according to claim 1, wherein multiple concave portions are formed and the anode is formed separately in each concave portion.

3. The solid electrolytic capacitor according to claim 1, wherein multiple concave portions are formed and the anode is continuously formed among the concave portions.

4. A solid electrolytic capacitor comprising a plurality of capacitor elements, wherein each element comprises the anode terminal, anode, dielectric layer and cathode according to claim 1.

5. The solid electrolytic capacitor according to claim 4, wherein the plurality of capacitor elements are stacked in a configuration wherein concave portions of each anode terminal face the same direction.

6. The solid electrolytic capacitor according to claim 4, wherein the plurality of capacitor elements are stacked in a configuration wherein concave portions on the anode terminal alternately face one direction and another direction.

7. The solid electrolytic capacitor according to claim 1, wherein the concave portion is inwardly tapered from the surface of the anode terminal.

8. The solid electrolytic capacitor according to claim 7, wherein a base angle of the concave portion is 45°-60°.

9. The solid electrolytic capacitor according to claim 1, wherein the depth of the concave portion is 100 μm-500 μm.

10. The solid electrolytic capacitor according to claim 1, wherein the ratio of the depth of the concave portion to the thickness of the anode terminal is 0.5-2.

11. The solid electrolytic capacitor according to claim 1, wherein the terminal main body has a lower electrical resistance than the valve metal layer.

12. The solid electrolytic capacitor according to claim 11, wherein the terminal main body comprises any one of copper, tungsten, nickel, titanium, silver, gold, platinum, rhodium, or an alloy that contains at least one of copper, tungsten, nickel, titanium, silver, gold, platinum, or rhodium.

13. The solid electrolytic capacitor according to claim 1, wherein the valve metal layer comprises any one of niobium, tantalum, titanium, aluminum, hafnium, zirconium, zinc, tungsten, bismuth, or antimony.

14. The solid electrolytic capacitor according to claim 1, wherein the thickness of the valve metal layer is 0.2 μm-1 μm.

15. The solid electrolytic capacitor according to claim 1, wherein the cathode and the anode are connected to a cathode lead frame and an anode lead frame, respectively, and the anode lead frame is exposed between end portions of the cathode lead frame exposed at the rear surface of the solid electrolytic capacitor.

16. A method for manufacturing a solid electrolytic capacitor comprising:
preparing an anode terminal having a concave portion,
forming a porous body anode comprising valve metal in the concave portion,
forming a dielectric layer on the anode by anodizing the anode, and
forming a cathode on the dielectric layer.

17. The method of manufacturing the solid electrolytic capacitor according to claim 16, wherein the concave portion is formed by laser beam irradiation.

18. The method of manufacturing the solid electrolytic capacitor according to claim 16, wherein the laser beam is pulsed.

19. The method of manufacturing the solid electrolytic capacitor according to claim 18, wherein the pulsed laser beam output power is gradually reduced.

20. The method of manufacturing the solid electrolytic capacitor according to claim 17, wherein the laser is a carbon dioxide laser.
